(19) United States
(12) Patent Application Publication
(10) Pub. No.: US 2018/0095522 A1
(43) Pub. Date: Apr. 5, 2018

(54) Scenario-Based Policy For Performance And Power Management In Electronic Apparatus

(71) Applicant: MediaTek Inc., Hsinchu City (TW)

(72) Inventors: Po-hua Huang, Hsinchu City (TW); Chien-Ming Chiu, Taoyuan City (TW)

(21) Appl. No.: 15/647,423

(22) Filed: Jul. 12, 2017

Related U.S. Application Data
(60) Provisional application No. 62/403,733, filed on Oct. 4, 2016.

(51) Int. Cl. G06F 1/32; G06F 11/30; G06F 9/50; G06F 11/34

(52) U.S. Cl. CPC G06F 1/3296; G06F 11/3055; G06F 9/5094; G06F 9/5061; G06F 1/3234; G06F 11/3409; G06F 11/34

(57) ABSTRACT

Concepts and examples pertaining to scenario-based policy for performance and power management in an electronic apparatus are described. A processor of an electronic apparatus determines whether an application currently executed on the electronic apparatus is of a predefined type of applications. The processor controls one or more aspects of operations of the electronic apparatus in executing the application responsive to the determining indicating the application being of the predefined type of applications.

### CROSS REFERENCE TO RELATED PATENT APPLICATION(S)

The present disclosure claims the priority benefit of U.S. Provisional Patent Application Ser. No. 62/403,733, filed 04 Oct. 2016, which is incorporated by reference in its entirety.

### TECHNICAL FIELD

The present disclosure is generally related to performance and power management and, more particularly, to scenario-based policy for performance and power management in an electronic apparatus.

### BACKGROUND

Unless otherwise indicated herein, approaches described in this section are not prior art to the claims listed below and are not admitted as prior art by inclusion in this section.

Portable electronic apparatuses such as smartphones typically are powered by an internal power supply or battery. Thus, it is imperative to manage or control power consumption by the electronic apparatus to maximize the battery life. With more and more mobile apps, features and functionalities supported by such a portable electronic apparatus, certain applications consume more power than others. For example, game apps tend to consume more power than non-game apps. Besides, from the perspective of performance, the focuses of game apps and non-game apps are different.

Existing approaches for management of power consumption include, for example, dynamic voltage and frequency scaling (DVFS) and hotplugging for Linux-based central processing units (CPUs). Another existing approach includes user space hints to control DVFS and/or hotplugging behavior involving loading, scheduler, touch event and white list of apps. However, under existing approaches, it is necessary to monitor process workload in order to decide frequencies and number of processor cores to turn on. Moreover, with existing approaches, there is a lack of visual hints of performance, e.g., in terms of frames per second (FPS).

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose various novel concepts and schemes pertaining to a scenario-based policy for a gaming low power (GLP) mode to match the performance and low power requirement on gaming scenario. The present disclosure also provides a real-time classification method to recognize or otherwise identify game apps from various types of apps for power saving decisions. Additionally, visual hints may be incorporated for decision of performance and power management in various implementations in accordance with the present disclosure.

In one aspect, a method may involve a processor of an electronic apparatus determining whether an application currently executed on the electronic apparatus is of a predefined type of applications. The method may also involve the processor controlling one or more aspects of operations of the electronic apparatus in executing the application responsive to the determining indicating the application being of the predefined type of applications.

In one aspect, an electronic apparatus may include a processor. The processor may include a determination circuit and a control circuit. The determination circuit may be capable of determining whether an application currently executed on the electronic apparatus is of a predefined type of applications. The control circuit may be capable of controlling one or more aspects of operations of the electronic apparatus in executing the application responsive to the determining indicating the application being of the predefined type of applications.

It is noteworthy that, although description provided herein may be in the context of gaming scenario or game apps, the proposed concepts, schemes and any variation(s)/derivative(s) thereof may be implemented for other types of apps or applications to effect performance and power management. For instance, the proposed concepts, schemes and any variation(s)/derivative(s) thereof in accordance with the present disclosure may be utilized to recognize or otherwise identify applications associated with high power consumption (which may not necessarily be game apps) to implement scenario-based policy for performance and power management. Thus, the scope of the proposed schemes is not limited to the description provided herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scheme in accordance with an implementation of the present disclosure.

FIG. 2 is a flowchart of an example scheme in accordance with an implementation of the present disclosure.

FIG. 3 is a diagram of an example scheme in accordance with an implementation of the present disclosure.

FIG. 4 is a diagram of an example scheme in accordance with an implementation of the present disclosure.

FIG. 5 is a block diagram of an example apparatus in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

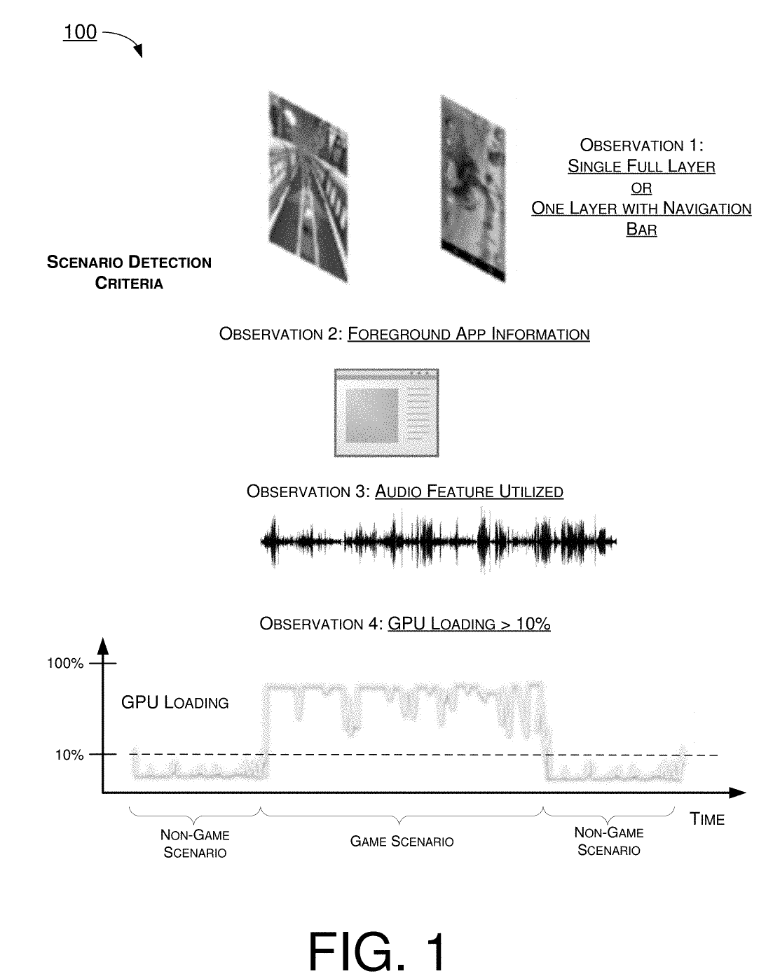

FIG. 1 illustrates an example scheme 100 of game detection in accordance with an implementation of the present disclosure. Solely for illustrative purposes and without limitation on the scope of the present disclosure, FIG. 1 shows example scheme 100 under which game scenarios and non-game scenarios may be detected. It is noteworthy that the proposed schemes may be applicable in various other implementations not related to game and non-game scenarios.

Under scheme 100, an electronic apparatus may be determined to be in a game mode (e.g., by executing a gaming application), and hence in a game scenario, as a result of various observations. In the example shown in FIG. 1, a first observation may be that the content being displayed by the electronic apparatus in connection with execution of an application is of a single full layer or one layer with a navigation bar. A second observation may be that any change in information related to a foreground application in execution may trigger a check point or otherwise indicate likelihood that the foreground app is a gaming application. A third observation may be that an audio feature (e.g., AudioTrack) is utilized in connection with the execution of the application. A fourth observation may be that a loading on a graphics processing unit (GPU) of the electronic apparatus is greater than a certain percentage (e.g., 10%) of a rated maximum loading of the GPU in connection with the execution of the application. Thus, under scheme 100, the application being executed by the electronic apparatus may be determined to be a gaming application, and hence a game scenario is detected, when all three observations are made or otherwise true. Additionally, under scheme 100, when any of the multiple observations is not made or otherwise untrue (e.g., does not exist), then it may be determined that the application being executed at the time is not a gaming application, and hence the electronic apparatus is in a non-game scenario during that period of time.

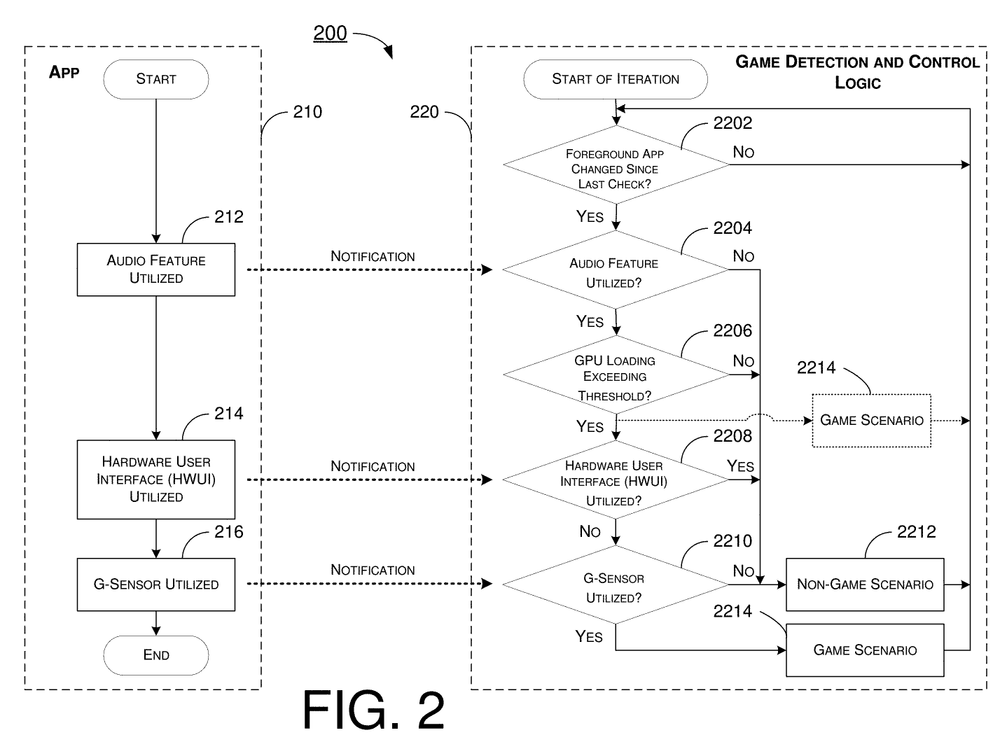

FIG. 2 illustrates an example scheme 200 of game detection in accordance with an implementation of the present disclosure. Solely for illustrative purposes and without limitation on the scope of the present disclosure, FIG. 2 shows example scheme 200 under which game scenarios and non-game scenarios may be detected. It is noteworthy that the proposed scheme may be applicable in various other implementations not related to game and non-game scenarios.

Scheme 200 may involve an application being executed by an electronic apparatus, shown as app 210 in FIG. 2, and a game detection and control logic 220. App 210 may, at various points in time, provide various notifications to game detection and control logic 220 during the execution of app 210 by the electronic apparatus. As shown in FIG. 2, at time 212, it may be detected that one or more audio features of the electronic apparatus (e.g., AudioTrack) is/are being utilized in connection with execution of app 210, and thus a corresponding notification may be provided to game detection and control logic 220. At time 214, it may be detected that one or more hardware user interfaces (HWUI) of the electronic apparatus (e.g., a push button) is/are not being utilized in connection with execution of app 210, and thus a corresponding notification may be provided to game detection and control logic 220. At time 216, it may be detected that a G-sensor of the electronic apparatus is being utilized in connection with execution of app 210, and thus a corresponding notification may be provided to game detection and control logic 220.

At game detection and control logic 220, a game detection and control process may be iteratively performed such that, during each iteration, a number of operations may be performed by game detection and control logic 220. For instance, at 2202, game detection and control logic 220 may determine whether the application being executed by the electronic apparatus (e.g., a foreground app) has changed since last check (e.g., during the previous iteration). In an event of a negative determination (i.e., no change in the foreground app), game detection and control logic 220 may start a next iteration of the game detection and control process. In an event of a positive determination (i.e., the foreground app has changed from one app to another), game detection and control logic 220 may proceed from 2202 to 2204.

At 2204, game detection and control logic 220 may, based on notification(s) from app 210 or lack thereof, determine whether an audio feature of the electronic apparatus is being utilized. In an event of a negative determination (i.e., no audio feature is being utilized), game detection and control logic 220 may proceed from 2204 to 2212, at which point game detection and control logic 220 may determine that the electronic apparatus is in a non-game scenario (e.g., app 210 is not a gaming application). In an event of a positive determination (i.e., one or more audio feature(s) is/are being utilized), game detection and control logic 220 may proceed from 2204 to 2206.

At 2206, game detection and control logic 220 may determine whether a loading of a GPU of the electronic apparatus is greater than, or exceeds, a predefined GPU loading threshold (e.g., 10% of a maximum loading of the GPU). In an event of a negative determination (i.e., the GPU loading threshold is not exceeded), game detection and control logic 220 may proceed from 2206 to 2212, at which point game detection and control logic 220 may determine that the electronic apparatus is in a non-game scenario (e.g., app 210 is not a gaming application). In an event of a positive determination (i.e., the GPU loading threshold is exceeded), game detection and control logic 220 may proceed from 2206 to 2208. Alternatively, in some implementations, in an event that both the determination at 2204 (that an audio feature is utilized) and the determination at 2206 (that the predefined GPU loading threshold is exceeded) are positive, game detection and control logic 220 may proceed from 2206 directly to 2214, at which point game detection and control logic 220 may determine that the electronic apparatus is in a game scenario (e.g., app 210 is a gaming application).

At 2208, game detection and control logic 220 may, based on notification(s) from app 210 or lack thereof, determine whether a HWUI of the electronic apparatus is being utilized. In an event of a negative determination (i.e., no HWUI is being utilized), game detection and control logic 220 may proceed from 2208 to 2212, at which point game detection and control logic 220 may determine that the electronic apparatus is in a non-game scenario (e.g., app 210 is not a gaming application). In an event of a positive determination (i.e., one or more HWUIs is/are being utilized), game detection and control logic 220 may proceed from 2208 to 2210.

At 2210, game detection and control logic 220 may, based on notification(s) from app 210 or lack thereof, determine whether a G-sensor of the electronic apparatus is being utilized. In an event of a negative determination (i.e., no G-sensor is being utilized), game detection and control logic 220 may proceed from 2210 to 2212, at which point game detection and control logic 220 may determine that the electronic apparatus is in a non-game scenario (e.g., app 210 is not a gaming application). In an event of a positive determination (i.e., a G-sensor is/are being utilized), game detection and control logic 220 may proceed from 2210 to 2214, at which point game detection and control logic 220 may determine that the electronic apparatus is in a game scenario (e.g., app 210 is a gaming application).

In some implementations, the criteria being determined at 2202, 2204, 2206, 2208 and 2210 may be assigned different weights, or weighting coefficients, such that one of the criteria may weight more than one or more other of the criteria. Moreover, each of the criteria under consideration may have a respective weight, or weighting coefficient, different from that of the other criteria under consideration. For illustrative purposes and without limitation, in one implementation, the criterion at 2204 (whether an audio feature is utilized) and the criterion at 2206 (whether the predefined GPU loading threshold is exceeded) may be assigned greater weights, or higher values of weighting coefficients, than the criteria at 2208 and 2210. This may be a way to prioritize those two criteria. In such cases, upon a determination that an audio feature is being utilized and that the predefined GPU loading threshold is exceeded, game detection and control logic 220 may determine that the electronic apparatus is in a game scenario (e.g., app 210 is a gaming application).

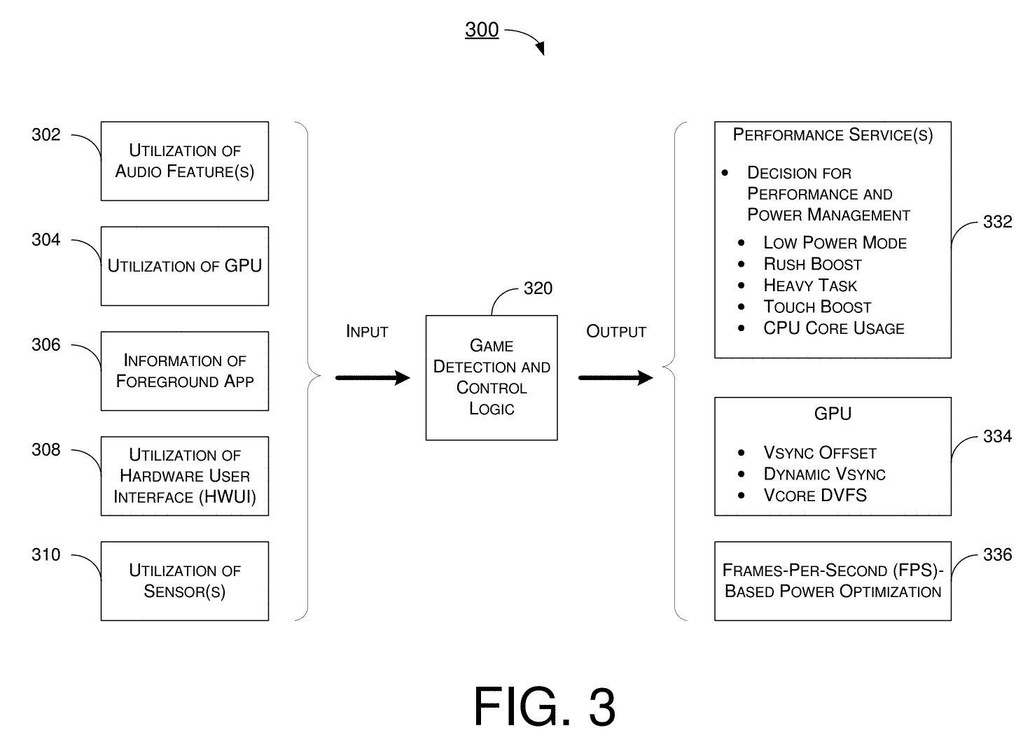

FIG. 3 illustrates an example scheme 300 in accordance with an implementation of the present disclosure. Solely for illustrative purposes and without limitation on the scope of the present disclosure, FIG. 3 shows example scheme 300 in the context of game and non-game scenarios. It is noteworthy that the proposed scheme may be applicable in various other implementations not related to game and non-game scenarios.

Scheme 300 may involve a game detection and control logic 320 receiving a number of inputs, such as inputs 302, 304, 306, 308 and 310, and performing a number of control operations as outputs, such as outputs 332, 334 and 336. Input 302 may be an input or notification that one or more audio features of an electronic apparatus (e.g., AudioTrack) is/are being utilized. Input 304 may be an input or notification regarding the loading, or level of utilization, of a GPU of the electronic apparatus. Input 306 may be an input or notification related to information of a foreground application currently being executed by the electronic apparatus. Input 308 may be an input or notification that one or more Hardware User Interfaces (HWUIs) of the electronic apparatus is/are being utilized. Input 310 may be an input or notification that one or more sensors of the electronic apparatus (e.g., G-sensor) is/are being utilized.

Based on the various inputs, game detection and control logic 320 may determine whether the electronic apparatus is in a game or non-game mode/scenario and, for game mode/scenario, carry out one or more control operations in accordance with the present disclosure to match the performance and lower power requirements for game scenarios. For instance, with inputs 302, 304, 306 and 310 being true and input 308 being untrue, game detection and control logic 320 may determine that the electronic apparatus is in a game mode/scenario.

In the example shown in FIG. 3, game detection and control logic 320 may perform operations, shown as outputs 332, 334 and 336, to implement a low power mode policy. Output 332 may include one or more CPU performance-related services and may involve game detection and control logic 320 making decisions related to performance and power management of CPU(s) of the electronic apparatus. For instance, in implementing the low power mode policy, game detection and control logic 320 may disable one or more of the following with respect to a CPU of the electronic apparatus: heavy task, rush boost, and touch boost. Alternatively or additionally, game detection and control logic 320 may adjust CPU core usage (e.g., adjusting a threshold for usage of one or more CPU cores of the electronic apparatus).

Output 334 may involve game detection and control logic 320 making decisions related to performance and power management of GPU(s) of the electronic apparatus. For instance, in implementing the low power mode policy, game detection and control logic 320 may disable one or more of the following: offset of a vertical synchronization (Vsync) signal with respect to a GPU of the electronic apparatus, a smart GPU boost with respect to the GPU, and dynamic voltage and frequency scaling (DVFS) for a core voltage (Vcore) supplied to a dynamic random-access memory (DRAM) of the electronic apparatus.

Output 336 may involve game detection and control logic 320 implementing frames-per-second (FPS)-based power optimization by adjusting CPU resources of the electronic apparatus being utilized according to FPS of images displayed by the electronic apparatus. For instance, game detection and control logic 320 may monitor the FPS of the images displayed by the electronic apparatus. Additionally, game detection and control logic 320 may compare the monitored FPS to a predefined FPS value. Based on a result of the comparing, game detection and control logic 320 may increase an amount of CPU resources of the electronic apparatus being utilized responsive to the comparing indicating the monitored FPS being less than the predefined FPS value. Conversely, game detection and control logic 320 may decrease the amount of CPU resources of the electronic apparatus being utilized responsive to the comparing indicating the monitored FPS being greater than the predefined FPS value.

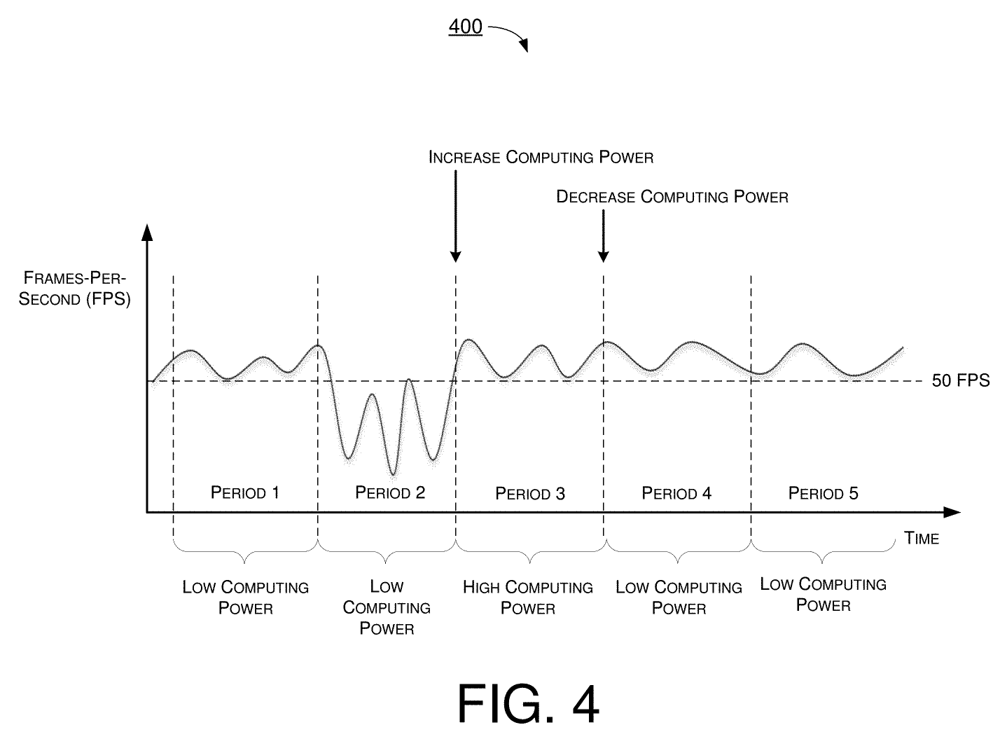

FIG. 4 illustrates an example scheme 400 in accordance with an implementation of the present disclosure. Scheme 400, as shown in FIG. 4, is an example scheme for implementing FPS-based power optimization (FPO). That is, scheme 400 may adjust a threshold of CPU core usage to favor more CPU cores with low frequency and fewer CPU cores with high frequency. Under scheme 400, the FPS of images being displayed by an electronic apparatus may be continually or at least periodically monitored. The value of the monitored FPS at any given point in time may be compared to a predefined FPS threshold. Under scheme 400, in an event that the monitored FPS is above the FPS threshold, computing power may be decreased (e.g., by removing one or more CPU cores currently being utilized). Under scheme 400, in an event that the monitored FPS is below the FPS threshold, computing power may be increased (e.g., by adding one or more CPU cores for utilization).

For instance, before implementation of scheme 400, the electronic apparatus may add one or more cores for usage when CPU utilization is greater than a first threshold (e.g., 95%), and remove one or more cores for usage when CPU utilization is less than a second threshold (e.g., 85%). Under scheme 400, the electronic apparatus may add one or more cores for usage when CPU utilization is greater than 80%, and remove one or more cores for usage when CPU utilization is less than 70%. Thus, under scheme 400, both the first threshold and the second threshold may be lowered.

In the example shown in FIG. 4, during the time of each of period 1, period 3, period 4 and period 5, the monitored FPS is above the FPS threshold (e.g., having a value of 50 FPS), and consequently low computing power is utilized (e.g., fewer CPU cores in use) for the subsequent period. During the time of period 2, the monitored FPS is below the FPS threshold, and consequently high computing power is utilized (e.g., more CPU cores in use) for the subsequent period (i.e., period 3).

### Illustrative Implementations

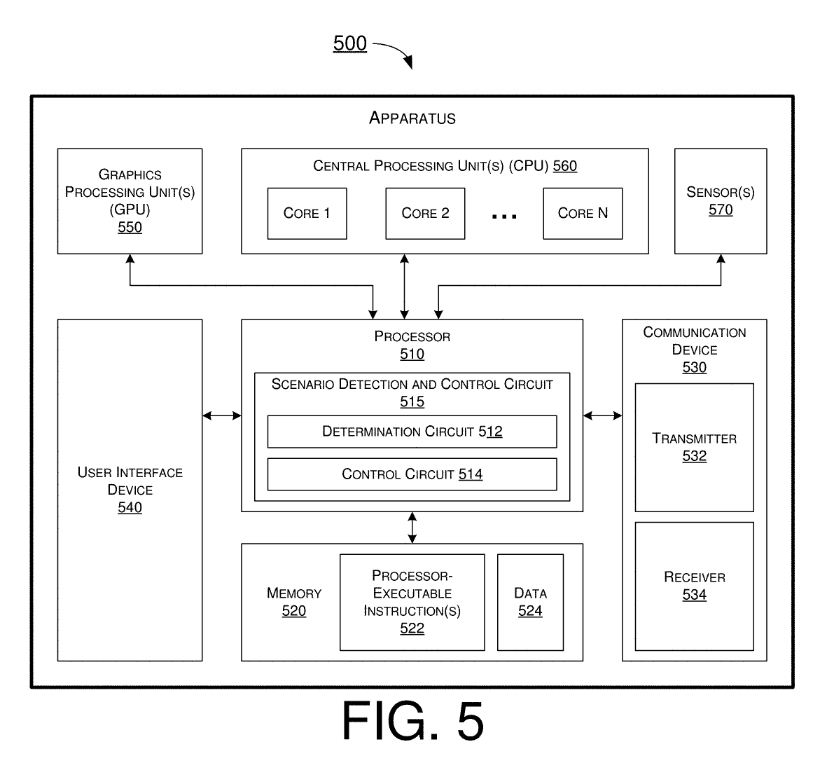

FIG. 5 illustrates an example apparatus 500 in accordance with an implementation of the present disclosure. Apparatus 500 may be capable of performing various functions, operations and/or tasks to implement concepts, schemes, techniques, processes and methods described herein pertaining to scenario-based policy for performance and power management in accordance with the present disclosure, including those described with respect to some or all of FIG. 1-FIG. 4 as well as process 600 described below.

Apparatus 500 may be an electronic apparatus such as a portable apparatus, a wearable apparatus or a standalone apparatus. For example and without limitation, apparatus 500 may be a smartphone, a smartwatch, a smart necklace, a smart bracelet, a tablet computer, a laptop computer, a notebook computer, a personal digital assistant, a desktop computer, a server, a communication device or a computing device. In some cases, apparatus 500 may be implemented, at least partly, in the form of one or more integrated-circuit (IC) chips such as, for example and without limitation, one or more single-core processors, one or more multi-core processors, or one or more complex-instruction-set-computing (CISC) processors.

Apparatus 500 may include one or more of those components shown in FIG. 5. For instance, apparatus 500 may include at least a processor 510. In one aspect, processor 510 may be implemented in the form of one or more single-core processors, one or more multi-core processors, or one or more CISC processors. That is, even though a singular term “a processor” is used herein to refer to processor 510, processor 510 may include multiple processors in some implementations and a single processor in other implementations in accordance with the present disclosure. In another aspect, processor 510 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, processor 510 is a special-purpose machine specifically designed, arranged and configured to perform specific tasks including scenario-based policy for performance and power management in accordance with various implementations of the present disclosure.

In some implementations, apparatus 500 may also include a memory 520, which may be a storage device configured to store one or more sets of codes, programs and/or instructions and/or data therein. In the example shown in FIG. 5, memory 520 stores one or more sets of processor-executable instructions 522 and data 524 therein. Memory 520 may be implemented by any suitable technology and may include volatile memory and/or non-volatile memory. For example, memory 520 may include a type of random access memory (RAM) such as dynamic RAM (DRAM), static RAM (SRAM), thyristor RAM (T-RAM) and/or zero-capacitor RAM (Z-RAM). Alternatively or additionally, memory 520 may include a type of read-only memory (ROM) such as mask ROM, programmable ROM (PROM), erasable programmable ROM (EPROM) and/or electrically erasable programmable ROM (EEPROM). Alternatively or additionally, memory 520 may include a type of non-volatile random-access memory (NVRAM) such as flash memory, solid-state memory, ferroelectric RAM (FeRAM), magnetoresistive RAM (MRAM) and/or phase-change memory.

In some implementations, apparatus 500 may include a communication device 530. For example and without limitation, communication device 530 may include a transceiver capable of communicating wirelessly in a single frequency band or multiple frequency bands (e.g., 2.4 GHz and/or 5 GHz). As shown in FIG. 5, communication device 530 may include a transmitter 532 capable of transmitting data (wirelessly and/or via a physical medium such as Ethernet cable, fiber optics, coaxial cable, digital subscriber line (DSL), twisted-pair copper wires or the like) and a receiver 534 capable of receiving data (wirelessly and/or via the physical medium).

In some implementations, apparatus 500 may include a user interface device 540 through which a user of apparatus 500 may interact with apparatus 500. User interface device 540 may include, for example and without limitation, a display, a touch-sensing display, a touch pad, a keyboard, a mouse, one or more sensors, one or more microphones and/or one or more speakers.

In some implementations, apparatus 500 may include one or more graphics processing units (GPUs) such as GPU 550 shown in FIG. 5. Although a single GPU 550 is shown in FIG. 5, it is noteworthy that in various implementations apparatus 500 may include more than one GPU 550.

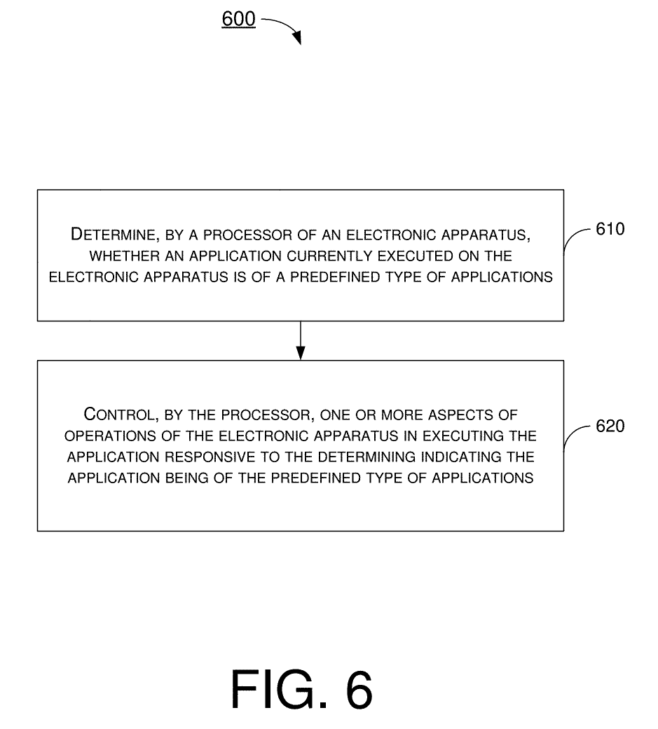

In some implementations, apparatus 500 may include one or more central processing units (CPUs) such as CPU 560 shown in FIG. 6. Although a single CPU 560 is shown in FIG. 5, it is noteworthy that in various implementations apparatus 500 may include more than one CPU 560. In some implementations, CPU 560 may be a multi-core CPU with multiple cores, such as core 1, core 2, core 3 . . . and core N shown in FIG. 5, with N being a positive integer greater than 1. It is also noteworthy that, although processor 510 is shown in FIG. 5 as being separate from CPU 560, in some implementations processor 510 and CPU 560 may be physically implemented in or as the same IC chip(s).

In some implementations, apparatus 500 may include one or more sensors such as sensor 570 shown in FIG. 5. Sensor 570 may represent, for example and without limitation, a G-sensor, a motion sensor and/or an accelerometer. Although a single sensor 570 is shown in FIG. 5, it is noteworthy that in various implementations apparatus 500 may include more than one sensor 570.

In some implementations, processor 510 may include a scenario detection and control circuit 515. Scenario detection and control circuit 515 may be capable of implementing various scenario detection schemes to render scenario-based policy for performance and power management in accordance with the present disclosure. For instance, scenario detection and control circuit 515 may perform operations, acts and/or tasks to implement examples shown in FIG. 1-FIG. 4. Moreover, scenario detection and control circuit 515 may be an example implementation of game detection and control logic 220 of FIG. 2 and/or game detection and control logic 320 of FIG. 3.

Scenario detection and control circuit 515 may include a determination circuit 512 and a control circuit 514. Determination circuit 512 may be capable of determining whether an application currently executed on apparatus 500 is of a predefined type of applications (e.g., game applications). Control circuit 514 may be capable of controlling one or more aspects of operations of apparatus 500 in executing the application responsive to the determining indicating the application being of the predefined type of applications.

In some implementations, in determining whether the application currently executed on apparatus 500 is of the predefined type of applications, determination circuit 512 may perform a number of operations. For instance, determination circuit 512 may determine whether an audio feature (e.g., AudioTrack) is utilized in connection with execution of the application. Moreover, determination circuit 512 may determine whether a loading of GPU 550 of apparatus 500 exceeds a predetermined threshold (e.g., 10% of the rated maximum loading of GPU 550). In such cases, determination circuit 512 may determine the application to be of the predefined type of applications responsive to determination circuit 512 determining that: (1) the audio feature is utilized in connection with the execution of the application, and (2) the loading of GPU 550 exceeds the predetermined threshold.

In some implementations, in determining whether the application currently executed on apparatus 500 is of the predefined type of applications, determination circuit 512 may perform additional operations. For instance, determination circuit 512 may determine whether a hardware user interface (HWUI) of apparatus 500 (e.g., user interface device 540) is utilized in connection with the execution of the application. Furthermore, determination circuit 512 may determine whether a G-sensor, a motion sensor or an accelerometer of apparatus 500 (e.g., sensor 570) is utilized in connection with the execution of the application. In such cases, determination circuit 512 may determine the application to be of the predefined type of applications responsive to determination circuit 512 determining that: (1) the audio feature is utilized in connection with the execution of the application, (2) the loading of GPU 550 exceeds the predetermined threshold, (3) the HWUI is not utilized in connection with the execution of the application, and (4) the G-sensor, motion sensor or accelerometer is utilized in connection with the execution of the application.

In some implementations, in controlling the one or more aspects of operations of apparatus 500 in executing the application, control circuit 514 may implement a low power mode policy by performing one or more of the following operations: (a) applying a low power mode for processor power management of CPU 560 of apparatus 500, (b) disabling a heavy task with respect to CPU 560, (c) disabling a rush boost with respect to CPU 560, (d) disabling a touch boost with respect to CPU 560, (e) disabling offset of a vertical synchronization (Vsync) signal with respect to GPU 550 of apparatus 500, (f) disabling a smart GPU boost with respect to GPU 550, (g) disabling dynamic voltage and frequency scaling (DVFS) for a core voltage (Vcore) supplied to a DRAM of apparatus 500 (e.g., memory 520), and (h) adjusting a threshold for usage of one or more CPU cores of apparatus 500.

In some implementations, in disabling the DVFS for the Vcore supplied to the DRAM of apparatus 500, control circuit 514 may set the Vcore to a predetermined voltage level (e.g., 0.9V).

In some implementations, in adjusting the threshold for usage of CPU 560 core of apparatus 500, control circuit 514 may perform a number of operations. For instance, control circuit 514 may lower a first threshold on CPU utilization for adding a first quantity of one or more CPU cores of apparatus 500 for usage (e.g., from 95% to 80%) when actual CPU utilization exceeds the first threshold. Moreover, control circuit 514 may lower a second threshold on CPU 560 utilization for removing a second quantity of one or more CPU cores of apparatus 500 for usage (e.g., from 85% to 70%) when the actual CPU utilization is below the second threshold. The first threshold may be higher than the second threshold.

In some implementations, in controlling the one or more aspects of operations of apparatus 500 in executing the application, control circuit 514 may implement frames-per-second (FPS)-based power optimization by adjusting CPU resources of apparatus 500 being utilized according to FPS of images displayed by apparatus 500. In some implementations, in adjusting CPU 560 resources of apparatus 500 according to resulted FPS in connection with the execution of the application, control circuit 514 may perform a number of operations. For instance, control circuit 514 may monitor the FPS of the images displayed by apparatus 500. Control circuit 514 may also compare the monitored FPS to a predefined FPS value. Control circuit 514 may increase an amount of CPU resources of apparatus 500 being utilized responsive to the comparing indicating the monitored FPS being less than the predefined FPS value. Control circuit 514 may decrease the amount of CPU resources of apparatus 500 being utilized responsive to the comparing indicating the monitored FPS being greater than the predefined FPS value.

FIG. 6 illustrates an example process 600 in accordance with an implementation of the present disclosure. Process 600 may represent an aspect of implementing the proposed concepts and schemes such as those described with respect to some or all of FIG. 1-FIG. 4. More specifically, process 600 may represent an aspect of the proposed concepts and schemes pertaining to scenario-based policy for performance and power management. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. The blocks/sub-blocks of process 600 may be executed iteratively. Process 600 may be implemented by or in apparatus 500 as well as any variations thereof. Solely for illustrative purposes and without limiting the scope, process 600 is described below in the context of apparatus 500. Process 600 may begin at block 610.

At 610, process 600 may involve processor 510 of apparatus 500 determining whether an application currently executed on apparatus 500 is of a predefined type of applications (e.g., game applications). Process 600 may proceed from 610 to 620.

At 620, process 600 may involve processor 510 controlling one or more aspects of operations of apparatus 500 in executing the application responsive to the determining indicating the application being of the predefined type of applications.

In some implementations, in determining whether the application currently executed on apparatus 500 is of the predefined type of applications, process 600 may involve processor 510 performing a number of operations. For instance, process 600 may involve processor 510 determining whether an audio feature is utilized in connection with execution of the application. Moreover, process 600 may involve processor 510 determining whether a loading of a GPU of apparatus 500 exceeds a predetermined threshold. In such cases, the application may be determined to be of the predefined type of applications responsive to a determination that: (1) the audio feature is utilized in connection with the execution of the application, and (2) the loading of the GPU exceeds the predetermined threshold.

In some implementations, in determining whether the application currently executed on apparatus 500 is of the predefined type of applications, process 600 may involve processor 510 performing additional operations. For instance, process 600 may involve processor 510 determining whether a hardware user interface (HWUI) of apparatus 500 is utilized in connection with the execution of the application. Process 600 may also involve processor 510 determining whether a G-sensor, a motion sensor or an accelerometer of apparatus 500 is utilized in connection with the execution of the application. In such cases, the application may be determined to be of the predefined type of applications responsive to a determination that: (1) the audio feature is utilized in connection with the execution of the application, (2) the loading of the GPU exceeds the predetermined threshold, (3) the HWUI is not utilized in connection with the execution of the application, and (4) the G-sensor, motion sensor or accelerometer is utilized in connection with the execution of the application.

In some implementations, in controlling the one or more aspects of operations of apparatus 500 in executing the application, process 600 may involve processor 510 implementing a low power mode policy by performing one or more of the following: (a) applying a low power mode for processor power management of a CPU of apparatus 500, (b) disabling a heavy task with respect to the CPU, (c) disabling a rush boost with respect to the CPU, (d) disabling a touch boost with respect to the CPU, (e) disabling offset of a Vsync signal with respect to a GPU of apparatus 500, (f) disabling a smart GPU boost with respect to the GPU, (g) disabling DVFS for a Vcore supplied to a DRAM of apparatus 500, and (h) adjusting a threshold for usage of one or more CPU cores of apparatus 500.

In some implementations, in disabling the DVFS for the Vcore supplied to the DRAM of apparatus 500, process 600 may involve processor 510 setting the Vcore to a predetermined voltage level (e.g., 0.9V).

In some implementations, in adjusting the threshold for usage of the CPU core of apparatus 500, process 600 may involve processor 510 performing a number of operations. For instance, process 600 may involve processor 510 lowering a first threshold on CPU utilization for adding a first quantity of one or more CPU cores of apparatus 500 for usage (e.g., from 95% to 80%) when actual CPU utilization exceeds the first threshold. Moreover, process 600 may involve processor 510 lowering a second threshold on the CPU utilization for removing a second quantity of one or more CPU cores of apparatus 500 for usage (e.g., from 85% to 70%) when the actual CPU utilization is below the second threshold. The first threshold may be higher than the second threshold.

In some implementations, in controlling the one or more aspects of operations of apparatus 500 in executing the application, process 600 may involve processor 510 implementing FPS-based power optimization by adjusting CPU resources of apparatus 500 being utilized according to FPS of images displayed by apparatus 500.

In some implementations, in adjusting the CPU resources of apparatus 500 according to resulted FPS in connection with the execution of the application, process 600 may involve processor 510 performing a number of operations. For instance, process 600 may involve processor 510 monitoring the FPS of the images displayed by apparatus 500. Process 600 may also involve processor 510 comparing the monitored FPS to a predefined FPS value. Process 600 may involve processor 510 increasing an amount of CPU resources of apparatus 500 being utilized responsive to the comparing indicating the monitored FPS being less than the predefined FPS value. Process 600 may involve processor 510 decreasing the amount of CPU resources of apparatus 500 being utilized responsive to the comparing indicating the monitored FPS being greater than the predefined FPS value.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an electronic apparatus, whether an application currently executed on the electronic apparatus is of a predefined type of applications; and
controlling, by the processor, one or more aspects of operations of the electronic apparatus in executing the application responsive to the determining indicating the application being of the predefined type of applications.

2. The method of claim 1, wherein the determining of whether the application currently executed on the electronic apparatus is of the predefined type of applications comprises:
determining whether an audio feature is utilized in connection with execution of the application; and
determining whether a loading of a graphics processing unit (GPU) exceeds a predetermined threshold.

3. The method of claim 2, wherein the application is determined to be of the predefined type of applications responsive to a determination that:
the audio feature is utilized in connection with the execution of the application; and
the loading of the GPU exceeds the predetermined threshold.

4. The method of claim 2, wherein the determining of whether the application currently executed on the electronic apparatus is of the predefined type of applications further comprises:
determining whether a hardware user interface (HWUI) of the electronic apparatus is utilized in connection with the execution of the application; and
determining whether a G-sensor of the electronic apparatus is utilized in connection with the execution of the application.

5. The method of claim 4, wherein the application is determined to be of the predefined type of applications responsive to a determination that:
the audio feature is utilized in connection with the execution of the application;
the loading of the GPU exceeds the predetermined threshold;
the HWUI is not utilized in connection with the execution of the application; and
the G-sensor is utilized in connection with the execution of the application.

6. The method of claim 1, wherein the controlling of the one or more aspects of operations of the electronic apparatus in executing the application comprises implementing a low power mode policy by performing one or more of:
applying a low power mode for processor power management of a central processing unit (CPU) of the electronic apparatus;
disabling a heavy task with respect to the CPU;
disabling a rush boost with respect to the CPU;
disabling a touch boost with respect to the CPU;
disabling offset of a vertical synchronization (Vsync) signal with respect to a graphics processing unit (GPU) of the electronic apparatus;
disabling a smart GPU boost with respect to the GPU;
disabling dynamic voltage and frequency scaling (DVFS) for a core voltage (Vcore) supplied to a dynamic random-access memory (DRAM) of the electronic apparatus; and
adjusting a threshold for usage of one or more CPU cores of the electronic apparatus.

7. The method of claim 6, wherein the disabling of the DVFS for the Vcore supplied to the DRAM of the electronic apparatus comprises setting the Vcore to a predetermined voltage level.

8. The method of claim 6, wherein the adjusting of the threshold for usage of the CPU core of the electronic apparatus comprises:
lowering a first threshold on CPU utilization for adding a first quantity of one or more CPU cores of the electronic apparatus for usage when actual CPU utilization exceeds the first threshold; and
lowering a second threshold on the CPU utilization for removing a second quantity of one or more CPU cores of the electronic apparatus for usage when the actual CPU utilization is below the second threshold,
wherein the first threshold is higher than the second threshold.

9. The method of claim 1, wherein the controlling of the one or more aspects of operations of the electronic apparatus in executing the application comprises implementing frames-per-second (FPS)-based power optimization by adjusting CPU resources of the electronic apparatus being utilized according to FPS of images displayed by the electronic apparatus.

10. The method of claim 9, wherein the adjusting of the CPU resources of the electronic apparatus according to resulted FPS in connection with the execution of the application comprises:
monitoring the FPS of the images displayed by the electronic apparatus;
comparing the monitored FPS to a predefined FPS value;
increasing an amount of CPU resources of the electronic apparatus being utilized responsive to the comparing indicating the monitored FPS being less than the predefined FPS value; and
decreasing the amount of CPU resources of the electronic apparatus being utilized responsive to the comparing indicating the monitored FPS being greater than the predefined FPS value.

11. An apparatus, comprising:
a processor comprising:
a determination circuit capable of determining whether an application currently executed on the apparatus is of a predefined type of applications; and
a control circuit capable of controlling one or more aspects of operations of the apparatus in executing the application responsive to the determining indicating the application being of the predefined type of applications.

12. The apparatus of claim 11, wherein, in determining whether the application currently executed on the apparatus is of the predefined type of applications, the determination circuit performs operations comprising:
determining whether an audio feature is utilized in connection with execution of the application; and
determining whether a loading of a graphics processing unit (GPU) exceeds a predetermined threshold.

13. The apparatus of claim 12, wherein the determination circuit determines the application to be of the predefined type of applications responsive to the determination circuit determining that:
the audio feature is utilized in connection with the execution of the application; and
the loading of the GPU exceeds the predetermined threshold.

14. The apparatus of claim 12, wherein, in determining whether the application currently executed on the apparatus is of the predefined type of applications, the determination circuit further performs operations comprising:
determining whether a hardware user interface (HWUI) of the apparatus is utilized in connection with the execution of the application; and
determining whether a G-sensor of the apparatus is utilized in connection with the execution of the application.

15. The apparatus of claim 14, wherein the determination circuit determines the application to be of the predefined type of applications responsive to the determination circuit determining that:
the audio feature is utilized in connection with the execution of the application;
the loading of the GPU exceeds the predetermined threshold;
the HWUI is not utilized in connection with the execution of the application; and
the G-sensor is utilized in connection with the execution of the application.

16. The apparatus of claim 11, wherein, in controlling the one or more aspects of operations of the apparatus in executing the application, the control circuit implements a low power mode policy by performing one or more operations of a plurality of operations comprising:
applying a low power mode for processor power management of a central processing unit (CPU) of the apparatus;
disabling a heavy task with respect to the CPU;
disabling a rush boost with respect to the CPU;
disabling a touch boost with respect to the CPU;
disabling offset of a vertical synchronization (Vsync) signal with respect to a graphics processing unit (GPU) of the apparatus;
disabling a smart GPU boost with respect to the GPU;
disabling dynamic voltage and frequency scaling (DVFS) for a core voltage (Vcore) supplied to a dynamic random-access memory (DRAM) of the apparatus; and
adjusting a threshold for usage of one or more CPU cores of the apparatus.

17. The apparatus of claim 16, wherein, in disabling the DVFS for the Vcore supplied to the DRAM of the apparatus, the control circuit sets the Vcore to a predetermined voltage level.

18. The apparatus of claim 16, wherein, in adjusting the threshold for usage of the CPU core of the apparatus, the control circuit performs operations comprising:
lowering a first threshold on CPU utilization for adding a first quantity of one or more CPU cores of the apparatus for usage when actual CPU utilization exceeds the first threshold; and
lowering a second threshold on the CPU utilization for removing a second quantity of one or more CPU cores of the apparatus for usage when the actual CPU utilization is below the second threshold,
wherein the first threshold is higher than the second threshold.

19. The apparatus of claim 11, wherein, in controlling the one or more aspects of operations of the apparatus in executing the application, the control circuit implements frames-per-second (FPS)-based power optimization by adjusting CPU resources of the apparatus being utilized according to FPS of images displayed by the apparatus.

20. The apparatus of claim 19, wherein, in adjusting the CPU resources of the apparatus according to resulted FPS in connection with the execution of the application, the control circuit performs operations comprising:
monitoring the FPS of the images displayed by the apparatus;
comparing the monitored FPS to a predefined FPS value;
increasing an amount of CPU resources of the apparatus being utilized responsive to the comparing indicating the monitored FPS being less than the predefined FPS value; and
decreasing the amount of CPU resources of the apparatus being utilized responsive to the comparing indicating the monitored FPS being greater than the predefined FPS value.
